(19) United States
(12) Patent Application Publication
(10) Pub. No.: US 2020/0271160 A1
(43) Pub. Date: Aug. 27, 2020

(54) LINEAR GUIDES WITH THERMAL COMPENSATION

(71) Applicant: HEWLETT-PACKARD DEVELOPMENT COMPANY, L.P., Spring, TX (US)

(72) Inventors: Victor Ruiz, Sant Cugat del Valles (ES); Matt G. Driggers, Vancouver, WA (US); Sergi Culubret, Sant Cugat del Valles (ES)

(21) Appl. No.: 16/608,855

(22) PCT Filed: Nov. 13, 2017
(86) PCT No.: PCT/US2017/061314

§ 371 Date: Oct. 27, 2019

(51) Int. Cl. F16C 29/02; B41J 25/34

(52) U.S. Cl. CPC F16C 29/02; F16C 2324/16; B41J 25/34

(57) ABSTRACT

Linear guides for shafts are disclosed The linear guides comprise housings having a main opening to receive the shaft and multiple contact guiding elements, such m bearings or sliders, arranged on the housing and around the opening, each contact guiding element to contact the shaft at a different point The linear guides further comprise thermal compensation blocks affixed to the housing and in contact with a portion of a contact guiding element of the multiple contact guiding elements.

### BACKGROUND

Carriages are used in a variety of functions to support, carry or transport equipment or material. Image forming apparatuses, such as two or three dimensional (2D or 3D) printers, sometimes include such carriages that are to be moved over or across a print bed to enable components included in the carriages to perform various operations during formation of an object. e.g. a 3D object. The carriages may be independently movable over the print bed and are to move along an axis or shaft.

Shafts are sometimes fitted with housings which may employ linear guides, such as bearings or sliders, in contact with the shaft to reduce stresses between the shaft and the housing.

In some image forming apparatuses, such as 3D printers, carriages are fitted with guides employing housings with multiple contact guiding elements to linearly guide the shafts when the image forming apparatus is in function.

### BRIEF DESCRIPTION

Some non-limiting examples of the present disclosure are described in the following with reference to the appended drawings, in which:

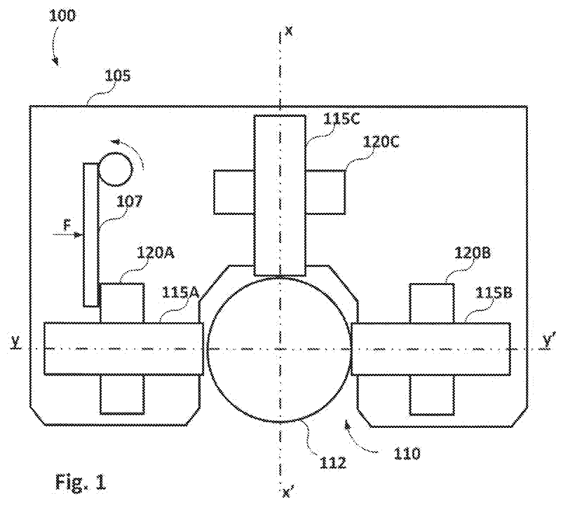

FIG. 1 schematically illustrates a linear guide with a preloading spring, according to an example.

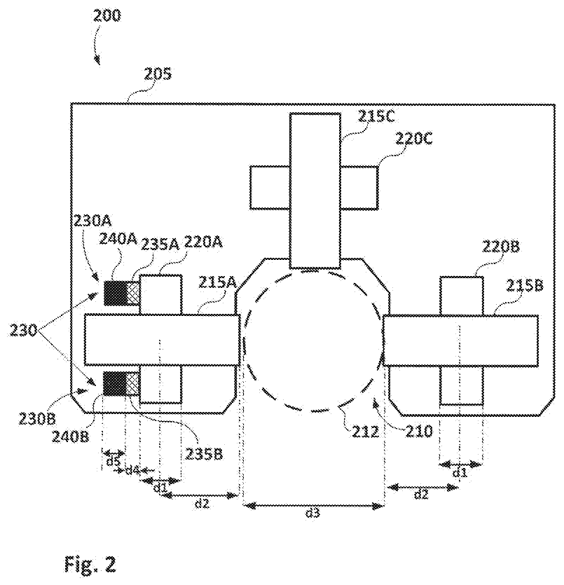

FIG. 2 schematically illustrates a linear guide with a thermal compensation block, according to an example.

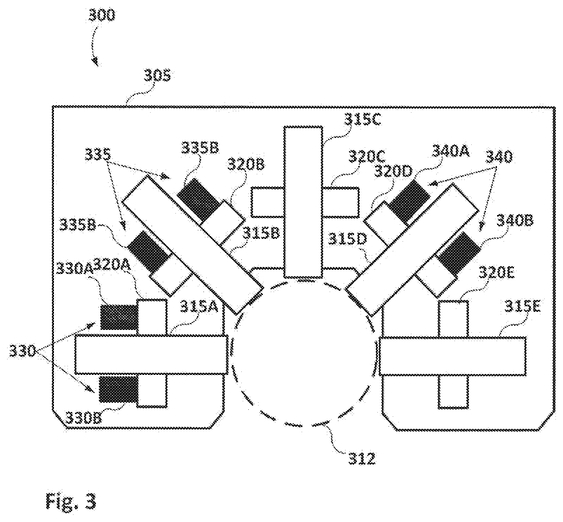

FIG. 3 schematically illustrates a linear guide with a thermal compensation block, according to another example.

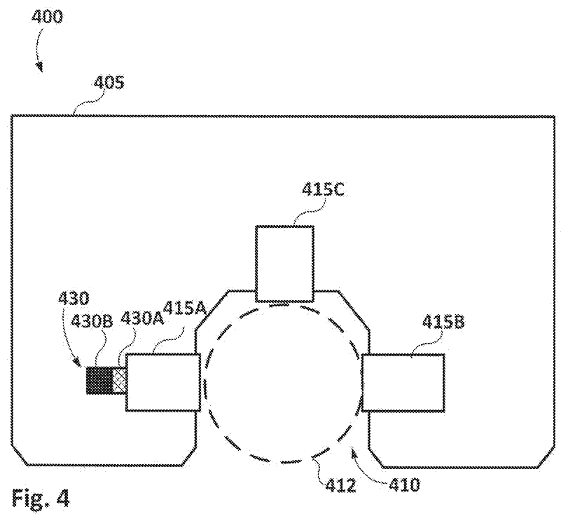

FIG. 4 schematically illustrates a linear guide with sliders and a thermal compensation block, according to another example.

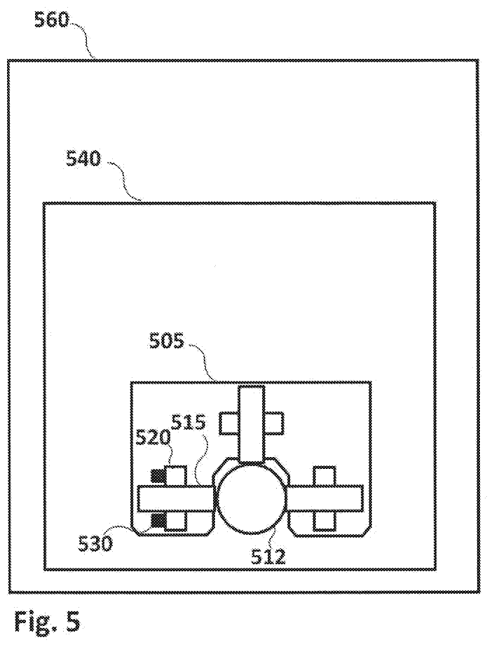

FIG. 5 schematically illustrates an image forming apparatus with a carriage, according to an example.

### DETAILED DESCRIPTION

FIG. 1 schematically illustrates a multi-bearing housing for a shaft with a preloading spring, according to an example. Multi-bearing housing 100 comprises a housing 105. The support plate 105 may be made of a first material, e.g. aluminium, and may be of a shape, e.g. U-shaped, defining an opening 110 for receiving a shaft 112. The support plate 105 may host multiple contact guiding elements, e.g. multiple bearings 115A, 1158, 115C rotatable around a pin 120A, 120B, 120C, respectively. The pins may be hosted in openings of the housing and may be affixed to the housing 105. Each bearing may have an inner ring rotatably coupled to the respective pin and an outer ring. The size of the bearings and the location of the pins may be selected and designed so that the outer ring to be in contact with a shaft 112, when a shaft 112 is introduced in the opening in a direction perpendicular to the plane defined by the housing 105. Thus, each outer ring of the bearings may contact the shaft at different points, respectively. In the example of FIG. 1, pin 120A and pin 120B are substantially parallel to the axis of symmetry x-x′ of the U-shaped opening so that the diameters of the outer rings of the bearings 115A, 115B to form a straight line y-y′ with the centre of the shaft, when the shaft is introduced in the opening. In other examples one or more of the bearings may be inclined with respect to the y-y′ axis. The outer rings of bearings 120A. 120B may contact the shaft at points corresponding to intersections of a horizontal diametric line of a cross section of the shaft. When the shaft is introduced in the opening, the bearing 120A, the shaft 112 and the bearing 120B may be arranged in a straight line to form a “bearing-shaft-bearing” system. The third pin 120C may be substantially coaxial to the axis of symmetry x-x′ of the U-shaped opening. Thus the respective outer ring of bearing 125C may contact the shaft at a point located 90 degrees clockwise and anticlockwise from the points in contact with bearings 125A and 1258, respectively.

The various pieces of the multi-bearing housing 100, namely the housing 105, the pins 120A, 120B, 120C and the bearings 115A, 115B, 115C, as well as the shaft 112 introduced in the opening, may be made of different materials. Each material may have a different thermal coefficient. When in use, the various pieces may heat up and expand unequally, each piece expanding according to its expansion coefficient (the expansion being a factor of its thermal coefficient and of its length). Thus contact between the shaft and one of the bearings of the “bearing-shaft-bearing” system may be lost. This may cause instability to the carriage and loss of accuracy. Some linear guides may use a preload mechanism, such as a spring 107 attached to the housing 105 The spring 107 may be in contact and push one of the pins, e.g. pin 120A, to generate a preloading force F in order to keep all the bearings in touch with the shaft during different temperatures as thermal coefficients of all the materials may not be the same and the materials may unequally expand.

Such a preloading force F may be applied constantly and may thus increase the Hertzian contact stresses, i.e. the stresses between the bearings and the shaft, and the Von Misses stresses, i.e. stresses used to predict yielding of materials under complex loading from the results of uniaxial tensile tests. By using spring 107, the preload force may be up to +100% of the force required with a system without preload. The linear guide 100 with preload may limit the acceleration of the carriage because the contact forces may reach the yield stress of the shaft 112 or of the bearing 115A.

FIG. 2 schematically illustrates a linear guide for a shaft, according to an example. Linear guide 200 comprises a housing 205. The housing 205 may define an opening 210 for receiving a shaft 212. The housing 205 may host three contact guiding elements, e.g. bearings 215A, 215B and 215C. Bearings 215A, 215B and 215C may be rotatable around pins 220A, 2208 and 220C, respectively. The pins 220A, 2208 and 220C may be hosted in openings of the housing 205 and may be affixed to the housing 205. Instead of a preload spring mechanism, the linear guide 200 may be provided with a thermal compensation block 230. The thermal compensation block 230 may be affixed to the support plate 205 and may be in contact with one or more of the pins parallel to the x-x′ axis, e.g. with pin 220A. Placement of the thermal compensation block 230 on the support plate 205 may be performed by using e.g. a loose fitting technique. In the example of FIG. 2 the thermal compensation block 230 is placed at an outer side of the pin 220A with respect to the shaft 212.

The thermal compensation block 230 may be distributed in two parts 230A and 230B along the pin on both sides of the respective bearing, one block part per side of the bearing. On one side of the bearing, the thermal compensation block 230A, 2308 may comprise a first portion 235A, 2358, respectively in contact with the pin. The first portion 235A, 2358 may be made of a material, e.g. steel, with a tensile strength higher than the tensile strength of the pin, to reduce stress on the pin. The thermal compensation block 230A, 230B may comprise a second portion 240A, 2408, respectively in contact with the first portion 235A, 2358, respectively. The second portion 235A, 2358 may be made by a material, e.g. zinc, with a thermal or expansion coefficient different than the thermal or expansion coefficient of the first portion's material. However, other materials with a thermal or expansion coefficient different than the thermal expansion coefficient of the first portion's material may be used.

During a heating event, the total elongation of the plate portion between the outer side of pin 120A and the outer side of block 230 may be calculated as:

TE₁=t*Cₕ(a+b+c+d+e) (Eq. 1)

In Eq. 1 t is the temperature, Cₕ is the thermal coefficient of the housing,

$$a = {d}_{1} + ( {d}_{2} - \frac{{d}_{1}}{2} ) ,$$

b=d₃,

$$c = \frac{{d}_{2}}{2} + \frac{{d}_{1}}{2} ,$$

d=d₄, e=d₅, wherein d₁ is the diameter of the pin, D₂ is the radius of a bearing, d₃ is the diameter of the shaft and d₄ is the width of the first portion of the plate.

During the same event, the total elongation of the respective portion of parts on the plate (i.e. the pins, the bearings, the shaft and the block) may be calculated as:

TE₂=t*(a*C_{br}+b*Cₛₕ+c*C_{br}+d*C₁ₚ+e*C₂ₚ) (Eq. 2)

Accordingly, C_{br} is the thermal coefficient of the bearing, Cₛₕ the thermal coefficient of the shaft. C₁ₚ the thermal coefficient of the first portion of the block and C₂ₚ the thermal coefficient of the second portion of the block.

Assuming TE₁=TE₂ then d₅ may be calculated as

$${d}_{5} = \frac{\begin{matrix}{C}_{h} * ( a + b + c + d ) - \\ ( a * {C}_{br} + b * {C}_{sh} + c * {C}_{br} + d * {C}_{1 p} )\end{matrix}}{- {C}_{h} + {C}_{2 p}} \qquad ( Eq . 3 )$$

Thus the size (i.e. the distance between proximal side and distal side of the second portion) of the second portion of the thermal compensation block may be calculated by knowing the various diameters and/or distances and thermal coefficients. The linear guide is thus modified in order to substitute the preloading spring, with a material that thermally compensates the dilatations between the housing and the system “bearing-shaft-bearing”, Thus the bearings may maintain contact with the shaft during the thermal event.

FIG. 3 schematically illustrates a linear guide for a shaft, according to another example. The linear guide 300 may comprise a housing 305 with multiple bearings 315A-315E distributed radially around the notional centre of the cross-section of the shaft 312 and rotationally coupled with respective pins 320A-320E, respectively. In the example of FIG. 3, the linear guide comprises contact guiding elements in the form of bearing and pin pairs. Furthermore, five such pairs are shown. In other examples the linear guide may comprise a different number of multiple contact guiding elements that may be either identical (e.g. pairs of bearings and pins or sliders) or different (for example a combination of bearing and pin pairs with sliders). The linear guide may comprise a first thermal compensation block 330, in contact with pin 320A. The thermal compensation block 330 may be distributed in two parts 330A, 330B along the outer side of the pin 320A and on both sides of the bearing 315A and may be made of a material with an expansion coefficient different (e.g. higher) than the expansion coefficient of at least the pin 320A. The linear guide 300 may further comprise a second thermal compensation block 335 in contact with pin 320B. The thermal compensation block 335 may be similarly distributed in two parts 335A. 3358 along the outer side of the pin 3208 and on both sides of the bearing 315B and may be made of a material similar or identical to the material of thermal compensation block 330. The linear guide 300 may further comprise a third thermal compensation block 340 in contact with pin 320D. The thermal compensation block 340 may be similarly distributed in two parts 340A, 3408 along the outer side of the pin 320D and on both sides of the bearing 315D and may also be made of a material similar or identical to the material of either thermal compensation block 330 or thermal compensation block 335. During a thermal event, e.g. during acceleration of the carriage along the shaft, the thermal compensation blocks 330, 335 and 340 may compensate dilatations between the housing 305 and the respective bearing and pin pairs. Thus the bearings may maintain contact with the shaft during the thermal event.

FIG. 4 schematically illustrates a linear guide with sliders and a thermal compensation block, according to another example. Linear guide 400 comprises a housing 405. The housing 405 may define an opening 410 for receiving a shaft 412. The housing 405 may host three contact guiding elements, e.g. sliders 415A, 4158 and 415C. Each slider may have a rectangular shape with a proximal side facing the opening 410. The linear guide 400 may be provided with a thermal compensation block 430. The thermal compensation block 430 may be affixed to the support plate 405 and may be in contact with a distal side of the one or more of the sliders. In the example of FIG. 4 the thermal compensation block 430 is illustrated in contact with the distal side of slider 415A.

The thermal compensation block 430 may comprise a first portion 430A in contact with the pin. The first portion 430A may be made of a material, e.g. steel, with a tensile strength higher than the tensile strength of the housing 405. The thermal compensation block 430 may comprise a second portion 430B in contact with the first portion 430A, respectively. The second portion 430B may be made of a material, e.g. zinc, with a thermal or expansion coefficient different than the thermal or expansion coefficient of the first portion's material. However, other materials with a thermal or expansion coefficient different than the thermal expansion coefficient of the first portion's material may be used. When the shaft is introduced in the opening, the slider 415A, the shaft 412 and the slider 4158 may be arranged in a straight line to form a “slider-shaft-slider” system. Similar calculations may thus be performed, as the ones performed for calculating the size of thermal compensation block in the example of FIG. 2, to calculate the size of thermal compensation block 430 or the size (i.e. the distance between proximal side and distal side) of the second portion 4308 of thermal compensation block 430. During a thermal event, e.g. during acceleration of the carriage along the shaft, the thermal compensation block 430 may compensate dilatations between the housing and the “slider-shaft-slider” system. Thus the sliders may maintain contact with the shaft during the thermal event.

FIG. 5 schematically illustrates an image forming apparatus with a carriage, according to an example. The image forming apparatus 500 may comprise carriage 550. Carriage 550 may be moveable along shaft 512. A linear guide 505 may comprise multiple contact guiding elements 515 to guide the carriage along the shaft. The linear guide 505 may have a main opening to host the shaft 512 and multiple contact guiding elements, e.g. bearings 515, in contact with the shaft. Each bearing may be rotatably associated with a pin 520. The pin 520 may be located on the linear guide 505 in a direction perpendicular to the shaft direction. The pin 520 may be in contact with a thermal compensation block 530. The thermal compensation block may be made of a material with a thermal coefficient different than the thermal coefficient of the linear guide.

All of the features disclosed in this specification (including any accompanying claims, abstract and drawings), and/or all of the operations of any method or process so disclosed, may be combined in any combination, except combinations where at least some of such features and/or operations are mutually exclusive.

Each feature disclosed in this specification (including any accompanying claims, abstract and drawings), may be replaced by alternative features serving the same, equivalent or similar purpose, unless expressly stated otherwise.

Although a number of particular implementations and examples have been disclosed herein, further variants and modifications of the disclosed devices and methods are possible. For example, not all the features disclosed herein are included in all the implementations, and implementations comprising other combinations of the features described are also possible. As such, representative examples of the present disclosure have utility over a wide range of applications, and the above discussion is not intended and should not be construed to be limiting, but is offered as an illustrative discussion of aspects of the disclosure. What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1. A linear guide for a shaft, comprising:
a housing having a main opening to receive the shaft,
multiple contact guiding elements arranged on the housing and around the opening, each contact guiding element to contact the shaft at a different point, and
a thermal compensation block, affixed to the housing and in contact with a portion of a contact guiding element of the multiple contact guiding elements.

2. The linear guide according to claim 1, wherein the thermal compensation block comprises a proximal part, in contact with the portion of the contact guiding element made of a first material and a distal part made of a second material.

3. The linear guide according to claim 2, wherein the second material has a thermal coefficient different than the thermal coefficient of the first material.

4. The linear guide according to claim 1, wherein the multiple contact guiding elements comprise sliders, wherein a proximal side of the slider is in contact with the shaft and wherein the thermal compensation block is in contact with a distal side of the slider.

5. The linear guide according to claim 1, wherein the multiple contact guiding elements comprise multiple pairs of pins and bearings, respectively, wherein the portion of a contact guiding element in contact with the thermal compensation block is a pin of a pair of the multiple pairs.

6. The linear guide according to claim 5, comprising three bearings rotatably coupled to three pins, respectively, wherein the thermal compensation block is in contact with one of the three pins.

7. The linear guide according to claim 5, wherein the thermal compensation block comprises a first block part and a second block part, the first block part being in contact with the pin on one side of the bearing and the second block part being in contact with the pin on the other side of the bearing.

8. The multi-bearing housing according to claim 1, wherein the housing comprises a U-shape and the multiple contact guiding elements are arranged around the opening.

9. The multi-bearing housing according to claim 2, wherein the first material is steel and the second material is zinc.

10. A carriage for an image forming apparatus, comprising:
a shaft,
a linear guide, having a housing to host the shaft and multiple contact guiding elements having a proximal side in contact with the shaft in a direction perpendicular to the shaft direction, wherein one or more of the multiple contact guiding elements comprises a first block, in contact with a distal side of the one or more contact guiding elements, made of a material with a tensile strength different than the tensile strength of the housing, and a second block, made of a material with an expansion coefficient different than the expansion coefficient of the first block.

11. The carriage according to claim 9, wherein the housing is attached to the carriage.

12. An image forming apparatus comprising:
a carriage, the carriage having a shaft; and
a linear guide for the shaft, the linear guide comprising a first bearing and a thermal compensation block, coupled to the first bearing, the first bearing and the shaft to form a bearing-shaft system, the thermal compensating block having a first portion made of a first material and a second portion made of a second material, the thermal coefficient of the first block being different than the thermal coefficient of the second block to thermally compensate a dilation between the linear guide and the bearing-shaft system.

13. The image forming apparatus according to claim 12, further comprising a second bearing, the bearing-shaft system comprising the first bearing, the shaft and the second bearing in a substantially straight line, wherein the shaft is between the first and the second bearing.

14. The image forming apparatus according to claim 13, further comprising a third bearing in contact with the shaft, in a direction perpendicular to the straight line of the bearing-shaft system.

15. The image forming apparatus according to claim 12, comprising three or more bearings, wherein one or more thermal compensation block is in contact with one or more of the bearings, respectively.
